(19) United States
(12) Patent Application Publication
(10) Pub. No.: US 2015/0323819 A1
(43) Pub. Date: Nov. 12, 2015

(54) ELECTRO-OPTIC MODULATORS

(71) Applicants: Juejun Hu, Newark, DE (US); Hongtao Lin, Newark, DE (US); Okechukwu Ogbuu, Newark, DE (US); Jifeng Liu, Hanover, NH (US); Lin Zhang, Cambridge, MA (US); Jurgen Michel, Cambridge, MA (US)

(72) Inventors: Juejun Hu, Newark, DE (US); Hongtao Lin, Newark, DE (US); Okechukwu Ogbuu, Newark, DE (US); Jifeng Liu, Hanover, NH (US); Lin Zhang, Cambridge, MA (US); Jurgen Michel, Cambridge, MA (US)

(73) Assignee: UNIVERSITY OF DELAWARE, NEWARK, DE (US)

(21) Appl. No.: 14/199,423

(22) Filed: Mar. 6, 2014

Related U.S. Application Data
(60) Provisional application No. 61/773,291, filed on Mar. 6, 2013.

(51) Int. Cl. G02F 1/035; G02F 1/00

(52) U.S. Cl. CPC G02F 1/035; G02F 1/0018

(57) ABSTRACT

Electro-optic modulators are disclosed. An electro-optic modulator includes an optical ring resonator, an optical waveguide, and a cavity of electro-optic material. The waveguide has a first portion positioned adjacent the resonator to create a first coupling region and a second portion positioned adjacent the resonator to create a second coupling region. The cavity of electro-optic material is embedded within the waveguide between the first portion and the second portion. A method of optical modulation includes the steps of receiving light into an optical waveguide, coupling a portion of the light from the waveguide into an optical ring resonator at a first coupling region between the waveguide and the resonator, transmitting the light remaining in the waveguide into a cavity of electro-optic material embedded within the waveguide, and transmitting the light from the cavity to a second coupling region between the waveguide and the resonator.

### CROSS REFERENCE TO RELATED APPLICATIONS

This application claims priority to U.S. Patent Application No. 61/773,291, the contents of which are incorporated herein by reference in their entirety.

### STATEMENT REGARDING FEDERALLY SPONSORED RESEARCH

This invention was made with support under Grant No. 1200406 from the National Science Foundation. The government may have rights in this invention.

### FIELD OF THE INVENTION

The present invention relates generally to modulator technology, and more particularly to electro-optic modulators.

### BACKGROUND OF THE INVENTION

Electro-optic (EO) modulators are optical devices in which material that exhibits the electro-optic effect is used to modulate an electrical signal (RF signal) on to a beam of light. In recent years, EO modulators have gained focus due to their wide variety of uses in broadband communication, RF-photonic links, millimeter wave imaging and phased-array radars. Important characteristics of EO modulators include operational speed, bandwidth, modulation efficiency, drive voltage, switching energy, and/or electro-optic response. EO modulators demonstrating improvements in these characteristics are desired.

### SUMMARY OF THE INVENTION

Aspects of the present invention are directed to electro-optic modulators.

In accordance with one aspect of the invention, an electro-optic modulator is disclosed. The electro-optic modulator includes an optical ring resonator, an optical waveguide, and a cavity of electro-optic material. The optical waveguide has a first portion positioned adjacent the optical ring resonator to create a first coupling region and a second portion positioned adjacent the optical ring resonator to create a second coupling region separate from the first coupling region. The cavity of electro-optic material is embedded within the optical waveguide between the first portion and the second portion.

In accordance with another aspect of the invention, a method of optical modulation is disclosed. The method includes the steps of receiving light into an optical waveguide, coupling a portion of the light from the optical waveguide into an optical ring resonator at a first coupling region between the optical waveguide and the optical ring resonator, transmitting the light remaining in the optical waveguide into a cavity of electro-optic material embedded within the optical waveguide, and transmitting the light from the cavity to a second coupling region between the optical waveguide and the optical ring resonator.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1A is a schematic diagram showing an exemplary electro-optic modulator in accordance with aspects of the present invention;

FIG. 1B is a block diagram showing the electro-optic modulator of FIG. 1A;

FIGS. 2A and 2B are images illustrating a top view of an exemplary cavity of the electro-optic modulator of FIG. 1A;

FIG. 2C is an image illustrating a side view of the exemplary cavity of FIGS. 2A and 2B; and

FIG. 3 is a graph of modulation energy vs. bandwidth of an exemplary electro-optic modulator in accordance with aspects of the present invention.

### DETAILED DESCRIPTION OF THE INVENTION

Aspects of the invention are described herein with reference to exemplary modulators that employ electro-optic (EO) material. As used herein, the term “EO material” is meant to encompass all suitable materials that exhibit an electro-optic effect. The disclosed modulators have a variety of applications including, but not limited to, sensing and detection, communication, RF photonic links, radar application, phased array antenna, millimeter imaging, or automobile collision detection. Other suitable applications will be known to one of ordinary skill in the art from the description herein.

The EO modulators disclosed herein may be particularly desirable in optical communication applications. Optical modulators and switches are critical building blocks for optical communication networks. As optical links progressively evolve to replace electrical wirings at the board and chip levels, power consumption and speed are increasingly becoming the limiting factors to further scale down the length of optical interconnects. To compete with existing electrical interconnect technologies, the energy consumption of optical modulators is preferably on the order of 10 fJ/bit or lower

One proposal for overcoming the aforementioned energy constraints involves leveraging optical resonant enhancement effects to reduce the footprint and thus energy consumption of modulator devices. In principle, the ultimate low switching energy can be attained in a nanoscale cavity which supports only a single resonant mode. Besides size scaling, cavities with high quality factors (Q) are extremely sensitive to intra-cavity refractive index perturbations or absorption change. Due to this unique feature, increasing cavity Q leads to reduced switching energy. However, high-Q also results in long cavity photon lifetime which limits the modulation bandwidth. This results in a trade-off between switching energy and modulation bandwidth for optical modulators.

In accordance with aspects of the present invention, the inventors have developed a novel coupling modulated dual cavity design to overcome the intra-cavity EO modulation limit discussed above. The concept of coupling modulation described herein enables modulation rates approaching the free spectral range (FSR) of the component micro-ring, which far exceeds the cavity photon lifetime limit. By incorporating a novel dual EO material/micro-ring resonant cavity structure, the disclosed embodiments can exhibit fast modulation up to approximately 100 GHz bandwidth while maintaining an ultra-low switching energy of in the order of 0.1 aJ or less, which is more than three orders of magnitude lower compared to state-of-the-art electro-optic modulator devices.

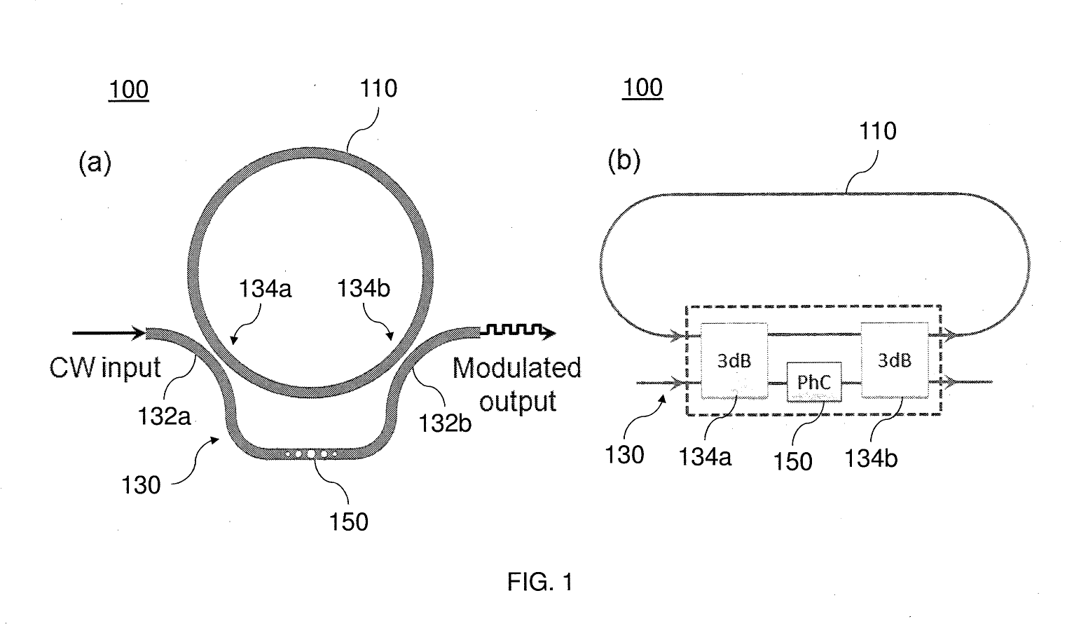

With reference to the drawings, FIGS. 1A and 1B illustrate an exemplary EO modulator 100 in accordance with aspects of the present invention. EO modulator 100 may be usable in an optical communication system to encode data bits onto a propagating beam of light. In general, EO modulator 100 includes an optical ring resonator 110, an optical waveguide 130, and a cavity 150 of EO material. Additional details of EO modulator 100 are described below.

Optical ring resonator 110 provides a first resonant cavity for the beam of light propagating through modulator 100. The size and materials of resonator 110 may be selected based on the wavelength of light being modulated by modulator 100. Suitable sizes and materials for optical ring resonator 110 will be known to one of ordinary skill in the art from the description herein.

Resonator 110 desirably has a particular high Q-factor. A high Q-factor is necessary to prevent loss of energy of the light resonating in resonator 110, and thereby maximize switching bandwidth of modulator 100. In a preferred embodiment, resonator 110 has a Q-factor of at least approximately 10⁵, and more preferably a Q-factor of approximately 5-6×10⁵. Furthermore, resonator 110 preferably has a propagation loss of no more than 1 dB/cm.

It is desirable that resonator 110 be particularly sensitive to coupling perturbations (i.e., coupling light from an external waveguide, as will be described below). Accordingly, resonator 110 may be processed to enhance its sensitivity to coupling perturbations. In an exemplary embodiment, resonator 110 is clad in a layer of material selected to increase its coupling sensitivity. Suitable materials include, for example, polymer-glass bismuth. Other suitable materials for enhancing the coupling sensitivity of resonator 110 will be known to one of ordinary skill in the art from the description herein.

While resonator 110 is described herein as a ring resonator, the invention is not so limited. It will be understood by one of ordinary skill in the art that other suitable shapes and structures of resonator 110 may be used without departing from the scope of the invention.

Optical waveguide 130 provides a path for the beam of light propagating through modulator 100. As with resonator 110, the materials of waveguide 130 may be selected based on the wavelength of light being modulated by modulator 100. Suitable materials for use in waveguide 130 will be known to one of ordinary skill in the art from the description herein.

Waveguide 130 forms a pair of coupling regions with resonator 110. Generally, optical coupling occurs when a first structure capable of supporting total internal reflection (TIR) of a propagating light beam (e.g., a waveguide) is positioned sufficiently close to a second structure also capable of supporting TIR of the light beam (e.g., a resonator). This causes a portion of the light beam to begin propagating (or in this example, resonating) within the second structure. Put simply, by positioning waveguide 130 sufficiently close to resonator 110, a portion of the light propagating in waveguide 130 will be transmitted into resonator 110. The amount of light coupled into resonator 110 is dependent on the distance between waveguide 130 and resonator 110, the length of the coupling region (along the direction of propagation), and the relative refractive indices between the two structures.

Waveguide 130 has a first portion 132a positioned adjacent resonator 110 to create a first coupling region 134a, and a second portion 132b positioned adjacent resonator 110 to create a second coupling region 134b. Second coupling region 134b is separate from first coupling region 134a. In an exemplary embodiment, first and second portions 132a and 132b comprise bends in waveguide 130, as shown in FIG. 1A. Each bend proceeds away from resonator 110, such that a midpoint in each bend forms the closest portion of waveguide 130 to resonator 110. It will be understood that the shape of waveguide 130 shown in FIG. 1A is not limiting, and that other shapes for waveguide 130 may be used without departing from the invention.

Cavity 150 of EO material provides a second resonant cavity for the beam of light propagating through modulator 100. As with resonator 110, the size and materials of cavity 150 may be selected based on the wavelength of light being modulated by modulator 100, as will be discussed in greater detail below.

Cavity 150 is embedded within waveguide 130 between first portion 132a and second portion 132b. Cavity 150 is used to affect the light propagating in waveguide 130. In particular, cavity 150 is electrically actuated (via an applied voltage) to change the index of the EO material therein. Such a change in the index of the EO material affects the phase of the light propagating from the first coupling region 134a to the second coupling region 134b. As will be discussed below, the propagating distance and time between the first and second coupling regions 134a and 134b in waveguide 130 can be selected to create a Mach-Zehnder type interferometer with the light resonating in resonator 110.

The size, shape, and material of cavity 150 are selected based on the wavelength of the propagating light. The EO material of cavity 150 preferably has a high EO coefficient, e.g., at least 200 pm/V, and more preferably, approximately 300 pm/V. Further, the EO material of cavity 150 preferable has a relatively low refractive index, e.g., no more than 1.6, and more preferably, approximately 1.5. In an exemplary embodiment, the EO material in cavity 150 comprises photonic crystal material. Other suitable EO materials will be known to one of ordinary skill in the art from the description herein.

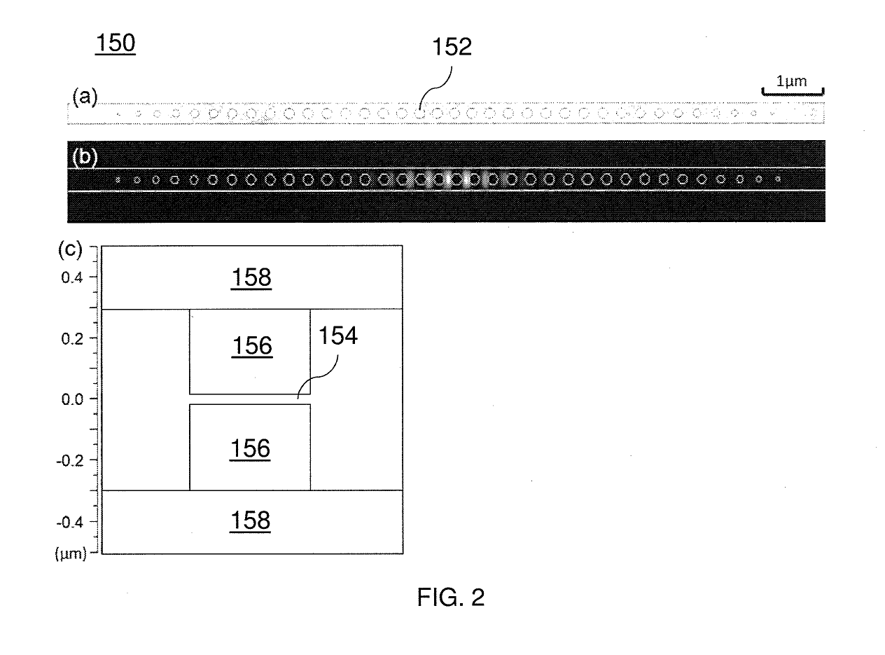

FIGS. 2A-2C show an exemplary embodiment of cavity 150 in accordance with aspects of the present invention. As shown in FIG. 2A, cavity 150 comprises an array of holes 152 in the EO material. The array of holes 152 extends in a direction of propagation of light through cavity 150.

The EO material of cavity 150 may be formed as a slot 154 of EO material, as shown in FIG. 2C. In an exemplary embodiment, slot 154 may have a thickness of approximately 20 nm, and a length of approximately 4 μm. Slot 154 is positioned between a pair of silicon layers 156 such that the pair of silicon layers 156 are positioned above and below slot 154. Cavity 150 may further comprise a pair of conductive layers 158 positioned above and below silicon layers 156, as shown in FIG. 2C.

Cavity 150 desirably has a substantially lower Q-factor than resonator 110. By integrating a high-Q ring resonator with a low-Q cavity, disclosed modulator 100 advantageously combines the merit of high-Q cavities in low power switching with the merit of low-Q cavities in short photon lifetime. In a preferred embodiment, cavity 150 has a Q-factor of no more than approximately 10³. Furthermore, cavity 150 preferably has a near-unity transmission (i.e., a transmission of at least 99%).

Modulator 100 may further comprise a voltage source (not shown) configured to apply a voltage across cavity 150. As discussed below, application of voltage across cavity 150 changes the index of the EO material, which affects the speed at which the light propagates from the first coupling region 134a to the second coupling region 134b.

The fabrication of suitable optical ring resonators for use as resonator 110 will be known to one of ordinary skill in the art. The fabrication of waveguide 130 and cavity 150 may be done through conventional lithography methods.

The operation of EO modulator 100 will now be described. As shown in FIG. 1A, optical waveguide 130 of modulator 100 receives as input a beam of continuous wave light. Once the light reaches first coupling region 134a, a portion of the light is coupled from waveguide 130 into optical ring resonator 110. Resonator 110 is designed such that the light continuously resonates around the ring. At the same time, the light in waveguide 130 propagates into cavity 150 of EO material. Cavity 150 is designed such that substantially all light (e.g. 99.6%) is transmitted therethrough and back into waveguide 130 toward second coupling region 134b. The extent of coupling between resonator 110 and waveguide 130 at second coupling region 134b is dependent on the relative phase between the light resonating in resonator 110 and the light propagating through waveguide 130.

In an exemplary embodiment, waveguide 130 and cavity 150 are configured such that a phase delay of the light propagating from first coupling region 134a to second coupling region 134b through waveguide 130 relative to light propagating through resonator 110 is approximately it when no voltage is applied across cavity 150. Such a configuration will result in destructive interference at second coupling region 134b, which prevents coupling of the light in waveguide 130 into resonator 110. This may be considered to be a situation where the light passing through modulator 100 is not modulated.

To modulate the light with modulator 100, a voltage is applied across cavity 150. Application of a voltage across cavity 150 changes a phase delay of light propagating from first coupling region 134a to second coupling region 134b through waveguide 130 relative to light propagating through resonator 110. This change in phase delay prevents the destructive interference that occurs when no voltage is applied, and results in at least some coupling of the light in waveguide 130 into resonator 110. When sufficient coupling occurs to cause the energy of the light in waveguide 130 to be attenuated by a predetermined amount (e.g., 3 decibels), this may be considered to be a situation where the light passing through modulator 100 has been modulated (in other words, a bit has been written onto the light). Notably, sufficient coupling may occur without requiring that a full π phase shift between the on and off states for cavity 150. Even a phase shift much less than π may be sufficient given a sufficiently high coupling sensitivity of resonator 110.

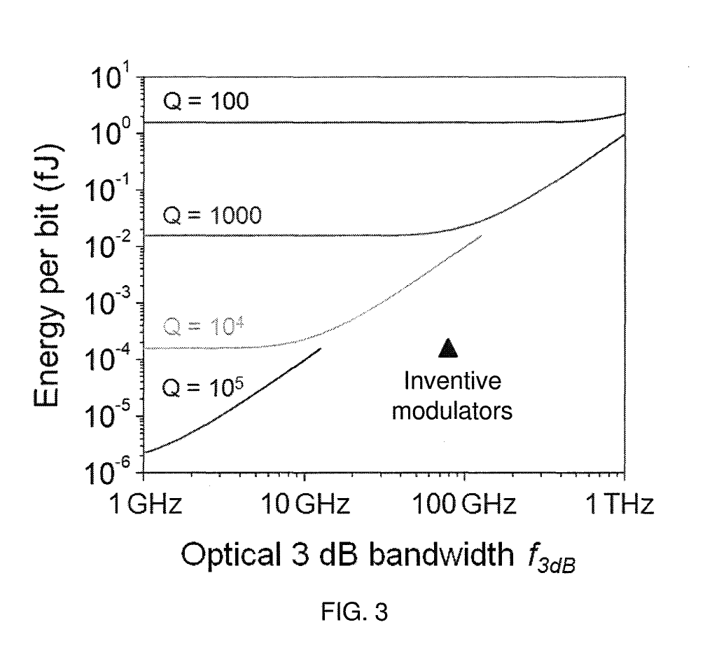

FIG. 3 is a graph of modulation energy vs. bandwidth for an exemplary EO modulator in accordance with aspects of the present invention. As shown in FIG. 3, the inventors have determined that conventional EO modulators have a theoretical limit for values of modulation energy vs. optical switching bandwidth (determined by the requirement of attenuating the light intensity by 3 dB). This is because increasing cavity Q-factor both reduces switching energy and increases cavity photon lifetime, which limits the modulation bandwidth. For example, a conventional EO modulator having a modulation energy of approximately 0.1 aJ (10⁻⁴ fJ) has an optical 3 dB bandwidth of no more than approximately 10 GHz.

However, the exemplary modulators disclosed herein are capable of achieving values of modulation energy vs. bandwidth that cannot be obtained by convention modulators. The modulation speed of the modulator devices disclosed herein is limited by two factors: the free spectral range of the optical ring resonator, and the bandwidth of the cavity of EO material. By integrating a high-Q optical ring resonator with a low-Q cavity, the disclosed modulators combine the merit of high Q cavities in low power switching with the merit of low Q cavities in short photon lifetime.

Preferably, the exemplary modulators of the present invention are capable of achieving a modulation energy of no more than approximately 1 aJ per bit while having an optical 3 decibel bandwidth of at least 50 GHz. More preferably, the exemplary modulators of the present invention are capable of achieving a modulation energy of no more than approximately 0.3 aJ per bit while having an optical 3 decibel bandwidth of at least 75 GHz.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. An electro-optic modulator comprising:
an optical ring resonator;
an optical waveguide having a first portion positioned adjacent the optical ring resonator to create a first coupling region and a second portion positioned adjacent the optical ring resonator to create a second coupling region separate from the first coupling region; and
a cavity of electro-optic material embedded within the optical waveguide between the first portion and the second portion.

2. The electro-optic modulator of claim 1, wherein the optical ring resonator has a Q-factor of at least approximately 10⁵.

3. The electro-optic modulator of claim 1, wherein the optical ring resonator is clad in a polymer-glass bismuth layer.

4. The electro-optic modulator of claim 1, wherein the first and second portions of the optical waveguide comprise bends in the optical waveguide.

5. The electro-optic modulator of claim 1, wherein the optical waveguide and the cavity are configured such that a phase delay of light propagating from the first coupling region to the second coupling region through the optical waveguide relative to light propagating from the first coupling region to the second coupling region through the optical ring resonator is approximately π.

6. The electro-optic modulator of claim 1, wherein the cavity has a Q-factor of no more than approximately 10³.

7. The electro-optic modulator of claim 1, wherein the cavity of electro-optic material comprises photonic crystal material.

8. The electro-optic modulator of claim 7, wherein the photonic crystal material comprises an array of holes therein extending in a direction of propagation of light through the cavity.

9. The electro-optic modulator of claim 1, wherein comprises a slot of electro-optic material, and a pair of silicon layers positioned above and below the slot.

10. The electro-optic modulator of claim 9, wherein the slot has a thickness of approximately 20 nm.

11. The electro-optic modulator of claim 9, wherein the slot has a length of approximately 4 μm.

12. The electro-optic modulator of claim 9, further comprises a pair of conductive layers positioned above and below the pair of silicon layers.

13. The electro-optic modulator of claim 1, further comprising a voltage source configured to apply a voltage across the cavity.

14. The electro-optic modulator of claim 13, wherein application of the voltage across the cavity changes a phase delay of light propagating from the first coupling region to the second coupling region through the optical waveguide relative to light propagating from the first coupling region to the second coupling region through the optical ring resonator.

15. The electro-optic modulator of claim 1, wherein the modulator has a modulation energy of no more than approximately 1 aJ per bit and an optical 3 decibel bandwidth of at least 50 GHz.

16. The electro-optic modulator of claim 15, wherein the modulator has a modulation energy of no more than approximately 0.3 aJ per bit and an optical 3 decibel bandwidth of at least 75 GHz.

17. A method of optical modulation comprising the steps of:
receiving light into an optical waveguide;
coupling a portion of the light from the optical waveguide into an optical ring resonator at a first coupling region between the optical waveguide and the optical ring resonator;
transmitting the light remaining in the optical waveguide into a cavity of electro-optic material embedded within the optical waveguide; and
transmitting the light from the cavity to a second coupling region between the optical waveguide and the optical ring resonator.

18. The method of claim 17, further comprising the steps of:
applying no voltage across the cavity of electro-optic material; and
transmitting the light in the optical waveguide through the second coupling region without coupling any portion of the light into the optical ring resonator.

19. The method of claim 17, further comprising the steps of:
applying a voltage across the cavity of electro-optic material; and
coupling another portion of the light from the optical waveguide into the optical ring resonator at the second coupling region.
